(19) United States
(12) Patent Application Publication
(10) Pub. No.: US 2009/0108730 A1
(43) Pub. Date: Apr. 30, 2009

(54) Plasma Display Panel

(76) Inventors: Sang-Hoon Yim, Suwon-si (KR); Shinichiro Nagano, Suwon-si (KR); Jeong-Nam Kim, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/230,944

(22) Filed: Sep. 8, 2008

(30) Foreign Application Priority Data
Oct. 30, 2007 (KR) 10-2007-0109496

(51) Int. Cl. H01J 1/62

(52) U.S. Cl. 313/489

(57) ABSTRACT

The provided is a plasma display panel (PDP) for inducing initial discharge as short-gap discharge to prevent an increase of a discharge firing voltage, suppressing the short-gap discharge after the initial discharge, and inducing full discharge as long-gap discharge to improve luminous efficiency. The PDP includes a first substrate, a second substrate, a barrier rib, a phosphor layer, address electrodes, first and second electrodes, a dielectric layer, and a protective layer. The first and second electrodes extend in the second direction, and form a first discharge gap therebetween. The dielectric layer is formed on the second substrate while covering the first and second electrodes. The protective layer covers the dielectric layer. The protective layer includes a first secondary electron emission portion and a second secondary electron emission portion. The first secondary electron emission portion is formed to correspond to an outer remote part of the first and second electrodes and has a first secondary electron emission coefficient. The second secondary electron emission portion is formed to correspond to an outer close part of one of the first and second electrodes, and has a second secondary electron emission that is smaller than the first secondary electron emission coefficient.

### CLAIM OF PRIORITY

This application makes reference to, incorporates the same herein, and claims all benefits accruing under 35 U.S.C. §119 from an application earlier filed in the Korean Intellectual Property Office on 30 Oct. 2007 and there duly assigned Serial No. 10-2007-0109496.

### BACKGROUND OF THE INVENTION

1. Field of the Invention

The present invention relates to a plasma display panel (PDP). More particularly, the present invention relates to a plasma display panel (PDP) for inducing initial discharge as a short-gap discharge to prevent an increase of a discharge firing voltage, suppressing the short-gap discharge after the initial discharge, and inducing full discharge as a long-gap discharge to improve luminous efficiency.

2. Description of the Related Art

In general, a plasma display panel (PDP) generates plasma with a gas discharge, excites phosphor with vacuum ultraviolet (VUV) rays emitted from the plasma, and implements images with red (R), green (G), and blue (B) visible light generated as the excited phosphor is stabilized.

In an AC-type plasma display panel (PDP), exemplarily, address electrodes are formed on a rear substrate and a dielectric layer is formed over the address electrodes. Barrier ribs are disposed between the address electrodes on the top of the dielectric layer in the form of stripes, and red (R), green (G), and blue (B) phosphor layers are formed on the barrier ribs.

Display electrodes composed of a pair of a sustain electrode and a scan electrode are formed on a front substrate facing the rear substrate in the direction across the address electrodes, and the display electrodes are covered with a dielectric layer and a MgO protective layer. A discharge cell is formed at the region where the address electrodes on the rear substrate and the display electrodes on the front substrate cross each other. More than millions of unit discharge cells are arranged inside the PDP in a form of a matrix (two-dimensional array).

In the PDP, the MgO protective layer formed on the dielectric layer covering the sustain electrode and the scan electrode emits secondary electrons when ions, electrons, and neutrons formed in the discharge cell by the discharge collide to the MgO protective layer. The MgO protective layer has a predetermined secondary electrode emission coefficient through the entire area of the front substrate.

As the secondary electron emission coefficient increases, the discharge firing voltage decreases. However, when the MgO protective layer has a high secondary electrode emission coefficient through the sustain electrodes and the scan electrodes, sustain discharge includes short-gap discharge and long-gap discharge. Accordingly, compared to the sustain discharge realized by the long-gap discharge, luminous efficiency is reduced by the short-gap discharge.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a plasma display panel (PDP) for inducing initial discharge as short-gap discharge to prevent an increase of discharge firing voltage, suppressing the short-gap discharge after the initial discharge, and inducing full discharge as long-gap discharge to improve luminous efficiency.

According to an exemplary embodiment of the present invention, a plasma display panel (PDP) includes first and second substrates, a barrier rib, a phosphor layer, an address electrode, a first electrode and a second electrode, a dielectric layer, and a protective layer. The first and second substrates are separately provided to face each other. The barrier rib is provided between the first and second substrates to define a discharge cell. The phosphor layer is formed in the discharge cell. The address electrode is formed on an inner surface of the first substrate and extends in a first direction. The first and second electrodes are formed on an inner surface of the second substrate and extend along the second direction. a first discharge gap is formed between the first electrode and the second electrode. The dielectric layer is formed on the second substrate while covering the first and second electrodes. The protective layer covers the dielectric layer. The protective layer includes a first secondary electron emission portion and a second secondary electron emission portion. The first secondary electron emission portion is formed to correspond to an outer remote part of the first and second electrodes, and has a first secondary electron emission coefficient. The second secondary electron emission portion is formed to correspond to an outer close part of one of the first and second electrodes, and has a second secondary electron emission coefficient that is smaller than the first secondary electron emission coefficient.

The second secondary electron emission portion may be formed to correspond to outer close parts of both of the first electrode and the second electrode.

The first secondary electron emission portion may be formed on the dielectric layer, and the second secondary electron emission portion may be formed on the first secondary electron emission portion.

The first secondary electron emission portion may include a MgO protective layer, and the second secondary electron emission portion may include a discharge deactivation film (DDF). The DDF includes Al₂O₃ or TiO₂.

The second secondary electron emission portion may form a second discharge gap that is greater than the first discharge gap.

The second secondary electron emission portion may cover the first discharge gap.

The second secondary electron emission portion may have a first width that is substantially the same as the second discharge gap and extending in the second direction.

The first and second electrodes may form a short-gap discharge portion by the outer close parts corresponding to the second secondary electron emission portion, and may form a long-gap discharge portion by the outer remote parts corresponding to the first secondary electron emission portion and outside of the second secondary electron emission portion.

The second secondary electron emission portion may include a plurality of sub-electron emission portions corresponding to a part of the first electrode and a part of the second electrode. The sub-electron emission portions may have a predetermined interval therebetween along the first direction, and each of the sub-electron emission portions has a third width measured along the first direction within a range of the first width.

The second secondary electron emission portion may include a first electrode side second secondary electron emission portion and a second electrode side second secondary electron emission portion. The first electrode side second secondary electron emission portion corresponds to a close part of the first electrode. The second electrode side second secondary electron emission portion is apart from the first electrode side second secondary electron emission portion on a first discharge gap side, and corresponds to a close part of the second electrode.

A gap between the first electrode side second secondary electron emission portion and the second electrode side second secondary electron emission portion may be greater than the first discharge gap. The gap may be the same as a sum of a first distance from a center of the discharge cell to the first electrode side second secondary electron emission portion and a second distance from the center of the discharge cell to the second electrode side second secondary electron emission portion, the second distance being the same as the first distance.

The first electrode side second secondary electron emission portion may have a second width extending in the second direction, and the second electrode side second secondary electron emission portion may have the second width extending in the second direction.

The first and second electrodes may form a short-gap discharge portion by the close parts corresponding to the first secondary electron emission portion and inside the second secondary electron emission portions and may form a long-gap discharge portion by the remote parts of the first electrode and the second electrode corresponding to the first secondary electron emission portion and outside the second secondary electron emission portion.

The first secondary electron emission portion is formed on the dielectric layer corresponding to the first electrode and the second electrode, and the second secondary electron emission portion is formed on the dielectric layer to correspond to a part of the first electrode and a part of the second electrode. the second secondary electron emission portion being formed on a portion of the dielectric layer on which the first secondary electron emission portion is not formed.

The second secondary electron emission portion may form a second discharge gap that is greater than the first discharge gap between the first and second electrodes in the first direction.

The second secondary electron emission portion may be cover the first discharge gap.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of a plasma display panel (PDP) according to a first exemplary embodiment of the present invention.

FIG. 2 is a cross-sectional view along a line II-II shown in FIG. 1.

FIG. 3 is a top plan view representing a relationship between discharge cells and electrodes shown in FIG. 1.

FIG. 4 is an exploded perspective view representing a discharge cell pattern and a protective layer pattern.

FIG. 5 is a cross-sectional view according to a second exemplary embodiment of the present invention.

FIG. 6 is a cross-sectional view according to a third exemplary embodiment of the present invention.

FIG. 7 is a cross-sectional view according to a fourth exemplary embodiment of the present invention.

FIG. 8 is a cross-sectional view according to a fifth exemplary embodiment of the present invention.

FIG. 9 is a cross-sectional view according to a sixth exemplary embodiment of the present invention.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

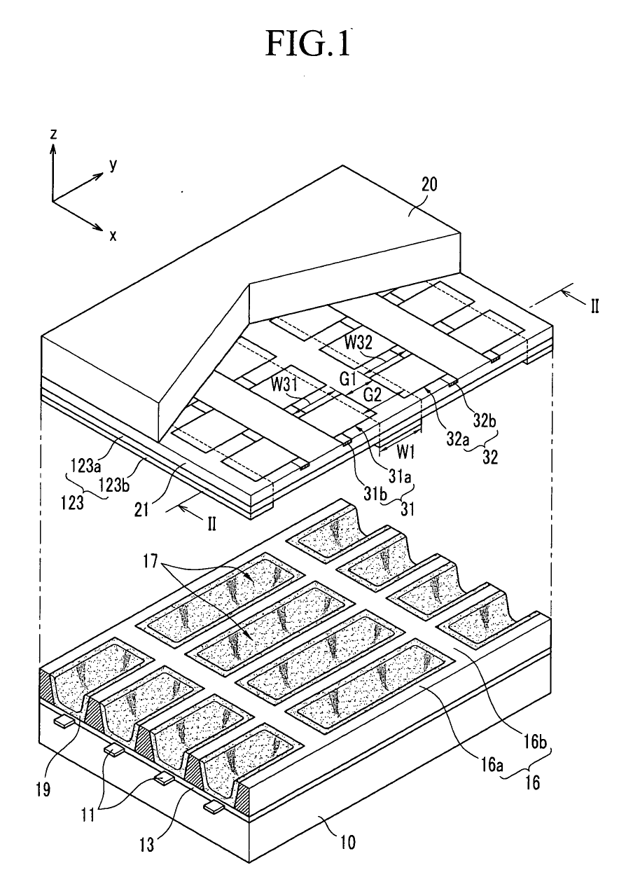

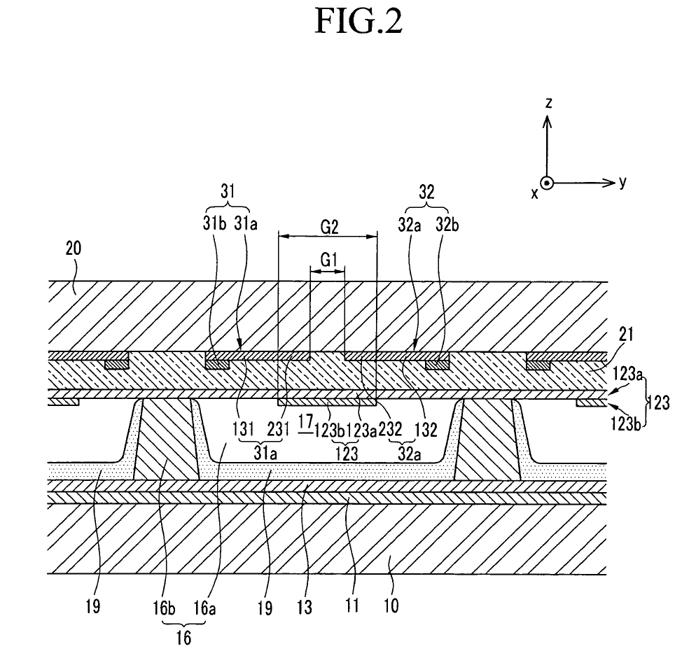

FIG. 1 is a perspective view of a plasma display panel (PDP) according to a first exemplary embodiment of the present invention, and FIG. 2 is a cross-sectional view along a line II-II shown in FIG. 1.

As shown in FIG. 1 and FIG. 2, the PDP of an exemplary embodiment includes rear and front substrates 10 and 20 that face each other and are sealed together. Barrier ribs 16 are formed between the rear and front substrates 10 and 20. The barrier ribs 16 are formed having a predetermined height to define a plurality of discharge cells 17. The discharge cells 17 are filled with a discharge gas including neon (Ne) and xenon (Xe), for example, to generate vacuum ultraviolet rays. Phosphor layers 19 are formed in the respective discharge cells 17.

In order to realize an image using gas discharge, the PDP further includes address electrodes 11, first electrodes (hereinafter referred to as “sustain electrodes”) 31, and second electrodes (hereinafter referred to as “scan electrodes”) 32, all of which are arranged about the discharge cells 17 between the rear and front substrates 10 and 20.

For example, the address electrodes 11 are formed on an inner surface of the rear substrate 10. The address electrodes 11 extend in a first direction (y-direction in FIG. 1) so that each of the address electrodes 11 continuously corresponds to the discharge cells 17 that are successively arranged in the y-direction. Further, the address electrodes 11 are spaced apart from each other in parallel in a second direction (x-direction in FIG. 1) about the discharge cells adjacently arranged in the second direction.

The address electrodes 11 are covered by a dielectric layer 13 covering the inner surface of the rear substrate 10. The dielectric layer 13 prevents positive ions or electrons from directly colliding to the address electrodes 11 to prevent the address electrodes 11 from being damaged, and forms and accumulates wall charges. The address electrodes 11 are disposed on the rear substrate 10 such that visible light is not prevented from being transmitted to the front, and therefore the address electrodes 11 may be formed as opaque electrodes. That is, the address electrodes 11 may be formed as metal electrodes having excellent electrical conductivity.

The barrier ribs 16 are provided on the dielectric layer 13 to partition the space between the rear and front substrates 10 and 20 into discharge cells 17. In other words, the barrier rib defines a discharge cell. The barrier ribs 16 includes first barrier rib members 16a extending in the y-axis direction and second barrier rib members 16b extending between the first barrier rib members 16a in the x-axis direction to arrange the discharge cells 17 in a two-dimensional array (a matrix form).

Further, the barrier ribs may be formed as the first barrier rib members extending in the y-axis direction to form the discharge cells in a stripe pattern (not shown). That is, the discharge cells may be open along the y-axis direction.

In the exemplary embodiment of the present invention, the barrier ribs 16 forming the discharge cells 17 in a matrix form are illustrated. In this case, when the second barrier rib members 16b are eliminated, the discharge cells are formed in a stripe pattern by the first barrier rib members 16a. Illustration of the discharge cells in the stripe pattern is omitted.

In the respective discharge cells 17, a phosphor paste is coated, dried, and baked on a surface of the first dielectric layer 13 positioned between the barrier ribs 16 and a side surface of the barrier ribs 16 to form the phosphor layers 19.

The phosphor layers 19 of the discharge cells 17 formed along the y-axis direction have the same color phosphor. In addition, red (R), green (G), and blue (B) phosphors are sequentially formed in the phosphor layers 19 in the discharge cells 17 sequentially disposed along the x-axis direction.

The sustain electrodes 31 and the scan electrodes 32 have a surface discharge structure such that they are formed on the inner surface of the front substrate 20 and correspond to the respective discharge cells 17 to cause a gas discharge from the discharge cells. The sustain electrodes 31 and the scan electrodes 32 are formed along the x-axis direction crossing the address electrodes 11.

The sustain electrodes 31 and the scan electrodes 32 respectively include transparent electrodes 31a and 32a for generating discharges, and bus electrodes 31b and 32b for applying a voltage signal to the transparent electrodes 31a and 32a. The transparent electrodes 31a and 32a generate surface discharges in the discharge cells 17, and are formed of transparent materials (e.g., indium tin oxide (ITO)) to obtain a sufficient aperture ratio of the discharge cell 17. The bus electrodes 31b and 32b are formed of metal materials having excellent electrical conductivity to compensate for the high electrical resistance of the transparent electrodes 31a and 32a.

The transparent electrodes 31a and 32a respectively form the surface discharge configuration while having widths W31 and W32 from a boundary to a center of the discharge cell 17 along the y-axis direction, and a discharge gap DG is formed at a center part of each discharge cell 17. The bus electrodes 31b and 32b are respectively disposed on the transparent electrodes 31 a and 32a, and extend along the x-axis direction at the boundary of the discharge cell 17. Accordingly, when the voltage signal is applied to the bus electrodes 31b and 32b, the voltage signal is applied to the transparent electrodes 31a and 32a respectively connected to the bus electrodes 31b and 32b.

In addition, the transparent electrode may be integrally formed along the x-axis direction to generate discharge in the respective discharge cells (not shown).

Referring back to FIG. 1 and FIG. 2, the sustain electrode 31 and the scan electrode 32 correspond to the discharge cell 17 while crossing the address electrodes 11, and the sustain electrode 31 and the scan electrode 32 are covered by the dielectric layer while being parallel to each other. The second dielectric layer 21 protects the sustain electrode 31 and the scan electrode 32 from the gas discharge, and forms and accumulates the wall charges when the discharge is generated.

A protective layer 123 is formed on the second dielectric layer 21 to cover the second dielectric layer 21. For example, the protective layer 123 is formed of MgO, protects the second dielectric layer 21, and emits secondary electrons when the discharge is generated.

When the PDP is driven, during a reset period, a reset discharge occurs by reset pulses applied to the scan electrodes 32. During an address period that follows the reset period, an address discharge occurs by scan pulses applied to the scan electrodes 32 and address pulses applied to the address electrodes 11. Thereafter, during a sustain period, a sustain discharge occurs by sustain pulses applied to the sustain electrodes 31 and the scan electrodes 32.

The sustain electrodes 31 and the scan electrodes 31 serve to apply the sustain pulses required for the sustain discharge. The scan electrodes 32 serve to apply the reset pulses and the scan pulses. The address electrodes 11 serve to apply the address pulses. The sustain electrodes 31, the scan electrodes 32, and the address electrodes 11 may have different roles, respectively, depending on voltage waveforms applied thereto, so they are not necessarily limited to the above-described roles.

In the PDP, discharge cells 17 to be turned on are selected by the address discharge according to the interaction of the address electrodes 11 and the scan electrodes 32, and discharge cells 17 selected by the sustain discharge according to interaction of the sustain electrodes 31 and the scan electrodes 32 are driven to display images.

In addition, the PDP according to the exemplary embodiment of the present invention further includes a configuration for generating initial discharge as short-gap discharge to prevent an increase of the discharge firing voltage, suppressing the short-gap discharge after the initial discharge, and generating full discharge as long-gap discharge to improve luminous efficiency.

For example, the protective layer 123 has two secondary electron emission coefficients. That is, the protective layer 123 has a higher secondary electron emission coefficient at an area corresponding to outer remote parts 131 and 132, which is located farther from a first discharge gap G1 that is formed between the sustain electrode 31 and the scan electrode 32. In addition, the protective layer 123 has a lower secondary electron emission coefficient at an area corresponding to outer close parts 231 and 232, which is located closer to the first discharge gap G1. In other words, the outer remote part is a portion around sustain electrode or scan electrode, which is located farther from the first discharge gap, and the outer close part is a portion around sustain electrode or scan electrode, which is located closer to the first discharge gap.

In further detail, the protective layer 123 includes a first secondary electron emission portion 123a and a second secondary electron emission portion 123b, which are partitioned according to an area corresponding to the sustain electrode 31 the scan electrode 32.

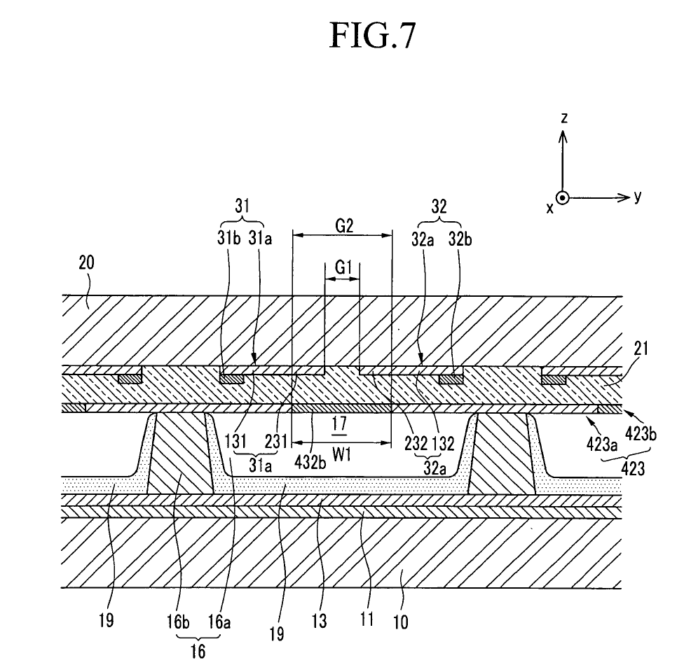

The first secondary electron emission portion 123a is formed to correspond to the sustain electrode 31 and the scan electrode 32, and has the first secondary electron emission coefficient while corresponding to at least the outer remote parts 131 and 132. The first secondary electron emission portion 123a may be formed to correspond to the entire area of the sustain electrode 31 and the scan electrode 32 (refer to FIG. 1 to FIG. 6), or it may be formed to correspond to the outer remote parts 131 and 132 (refer to FIG. 7 to FIG. 9).

The second secondary electron emission portion 123b has the second secondary electron emission coefficient while corresponding to the outer close parts 231 and 232, and is formed at one side or both sides of the first discharge gap G1. The second secondary electron emission portion 123b may be formed as a separate layer from the first secondary electron emission portion 123a (refer to FIG. 1 to FIG. 6), or it may be formed as the same layer as the first secondary electron emission portion 123a (refer to FIG. 7 to FIG. 9).

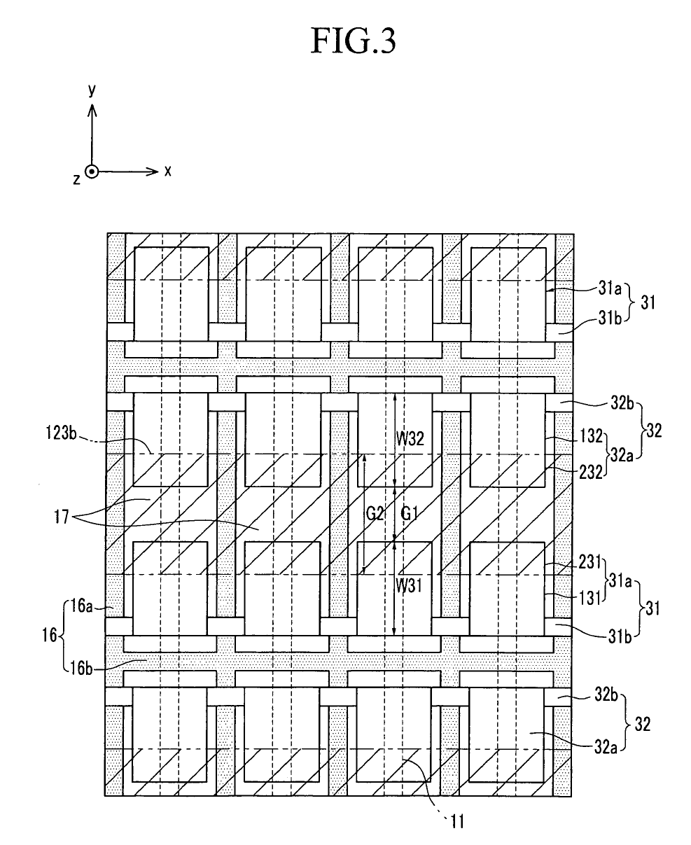

The outer close parts 231 and 232 are adjacent to outer sides of the first discharge gap G1 along the x-axis direction in one discharge cell 17, and the outer remote parts 131 and 132 are far from the first discharge gap G1 and close to the barrier ribs 16. The outer close parts 231 and 232 and the outer remote parts 131 and 132 are relative positions when viewed from the x-axis direction. A boundary between the outer close parts 231 and 232 and the outer remote parts 131 and 132 along y-axis is determined by the second secondary electron emission portion 123b (refer to FIG. 3). The second secondary electron emission coefficient is smaller than the first secondary electron emission coefficient.

The first secondary electron emission portion 123a covers most parts of the sustain electrode 31 and the scan electrode 32, and an amount of emitted secondary electrons increases by the higher first secondary electron emission coefficient.

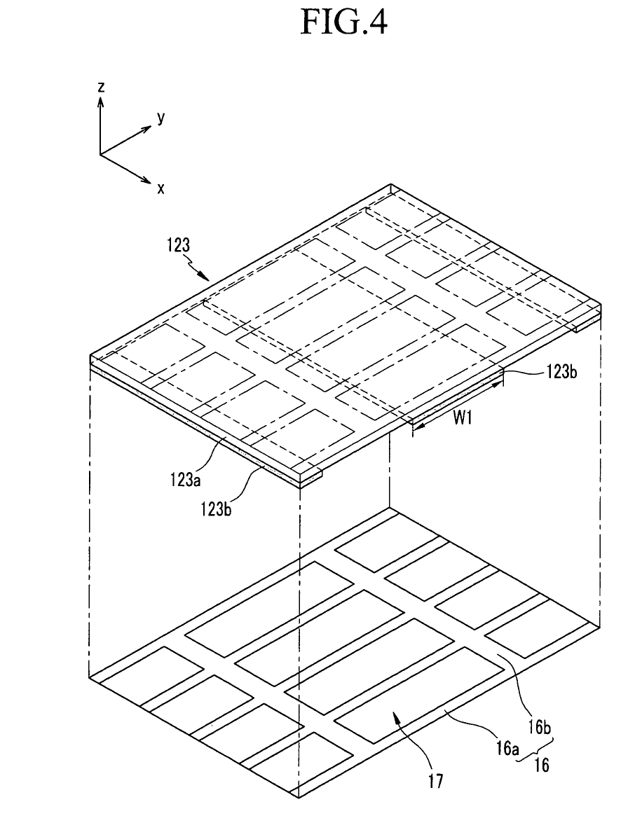

Referring to FIG. 1, FIG. 2, and FIG. 4, the first secondary electron emission portion 123a fully covers the sustain electrode 31 and scan electrode 32.

The outer close parts 231 and 232 are covered by the second secondary electron emission portion 123b with respect to one of the sustain electrode 31 and the scan electrode 32 or the respective sustain electrode 31 and scan electrode 32, and an amount of emitted secondary electrons decreases by the lower second secondary electron emission coefficient.

Referring to FIG. 1, FIG. 2, and FIG. 4, the second secondary electron emission portion 123b integrally covers the first discharge gap G1 and the outer close parts 231 and 232.

A second discharge gap G2 is formed between portions of the sustain electrode 31 and the scan electrode 32 corresponding to outermost parts of the second secondary electron emission portion 123b, respectively. The second discharge gap G2 is greater than the first discharge gap G1. That is, the second secondary electron emission portion 123b suppress the short-gap discharge between the outer close parts 231 and 232 of the sustain electrode 31 and the scan electrode 32.

For example, the sustain electrode 31 and the scan electrode 32 generate low voltage discharge through a shorter gap in the outer close parts 231 and 232 despite the lower second secondary electron emission coefficient of the initial discharge. Subsequently after the initial discharge, the sustain electrode 31 and the scan electrode 32 generate the full discharge through a longer gap in the outer remote parts 131 and 132 since the second secondary electron emission portion 123b functions as an obstacle of the short-gap discharge. That is, the second secondary electron emission portion 123b suppresses the short-gap discharge and generates the full discharge as the long-gap discharge. Accordingly, the sustain electrode 31 and the scan electrode 32 realize higher luminous efficiency.

Referring back to FIG. 1, FIG. 2, and FIG. 4, as the second secondary electron emission portion 123b corresponds to portions of the sustain electrode 31 and the scan electrode 32, the second secondary electron emission portion 123b corresponds to at least the outer close parts 231 and 232. Accordingly, the second secondary electron emission portion 123b is not biased toward the sustain electrode 31 or the scan electrode 32 while having the first discharge gap G1 between the sustain electrode 31 and the scan electrode 32, and may suppress the short-gap discharge at a center of the discharge cell 17 in the y-axis direction.

The second secondary electron emission portion 123b is integrally formed to correspond to the outer close parts 231 and 232 of the sustain electrode 31 and the scan electrode 32. Accordingly, the second discharge gap G2 in the y-axis direction is formed on a portion of the sustain electrode 31 and the scan electrode 32 corresponding to a portion between both ends of the second secondary electron emission portion 123b.

The second discharge gap G2 is greater than the first discharge gap G1. Since the second discharge gap G2 is determined by the secondary electron emission portion, the second discharge gap G2 has an indistinct boundary compared to the first discharge gap G1 determined by ends of the sustain electrode 31 and the scan electrode 32.

A short-gap discharge portion is formed on a portion of the sustain electrode 31 and scan electrode 32 by the outer close parts 231 and 232 corresponding to the second secondary electron emission portion 123b, and a long-gap discharge portion is formed by the outer remote parts 131 and 132 corresponding to the first secondary electron emission portion 123a and outside of the second secondary electron emission portion 123b.

Referring to FIG. 3 and FIG. 4, the second secondary electron emission portion 123b is formed along the x-axis direction while having a first width W1 that is substantially the same as the second discharge gap G2. In addition, in the PDP, the second secondary electron emission portion 123b are disposed to be apart from each other in the y-axis direction of the discharge cell 17 as shown in FIG. 3.

The second secondary electron emission portion 123b suppresses the short-gap discharge in the first discharge gap G1, but it has the secondary electron emission coefficient for generating the initial discharge. In the second secondary electron emission portion 123b, a part corresponding to the outer close parts 231 and 232 suppresses the discharge after the initial discharge, and allows the outer remote parts 131 and 132 to generate the long-gap discharge when generating the full discharge.

That is, when generating the full discharge, the second secondary electron emission portion 123b corresponding to the outer close parts 231 and 232 suppresses the short-gap discharge from the outer close parts 231 and 232. Not having the second secondary electron emission portion 123b, the first secondary electron emission portion 123a corresponding the outer remoter parts 131 and 132 generates the full discharge as the long-gap discharge. That is, since the short-gap discharge is suppressed and long-gap discharge is induced, the luminous efficiency may be improved.

The first secondary electron emission portion 123a is formed on the second dielectric layer 21 and the second secondary electron emission portion 123b is formed on the first secondary electron emission portion 123a. In a forming process of the protective layer 123, the second secondary electron emission portion 123b may be formed in an additional process without processing the first secondary electron emission portion 123a.

The first secondary electron emission portion 123a has a secondary electron emission coefficient that is greater than that of the second secondary electron emission portion 123b. For example, the first secondary electron emission portion 123a is formed as a MgO protective layer, and the second secondary electron emission portion 123b may be formed as a discharge deactivation film (DDF). The DDF may include Al₂O₃ or TiO₂. The first and second secondary electron emission portions 123a and 123b include a material for forming the second discharge gap G2 by a difference between the secondary electron emission coefficients of the first and second secondary electron emission portions 123a and 123b.

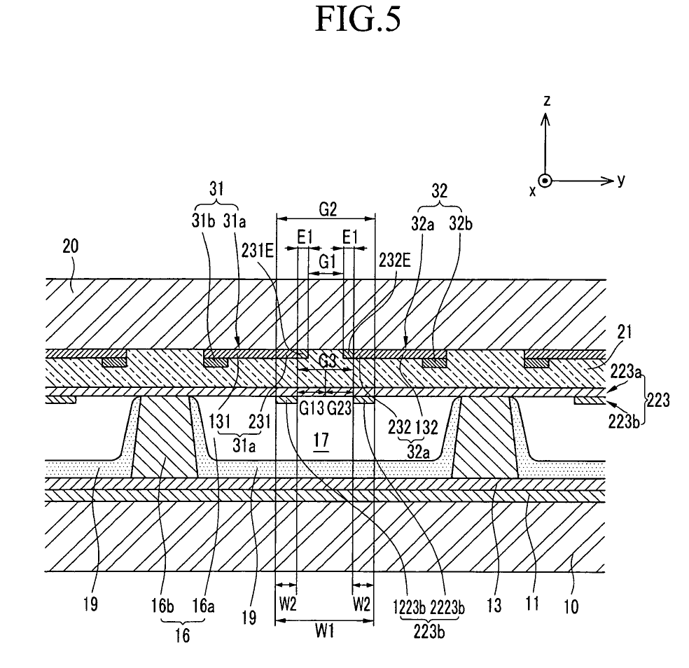

FIG. 5 to FIG. 9 show second to sixth exemplary embodiments of the present invention. Configurations and functions of the second to sixth exemplary embodiments of the present invention are similar to or the same as those of the first exemplary embodiment of the present invention, and therefore parts that are similar to or the same as that of the first exemplary embodiment of the present invention will be omitted.

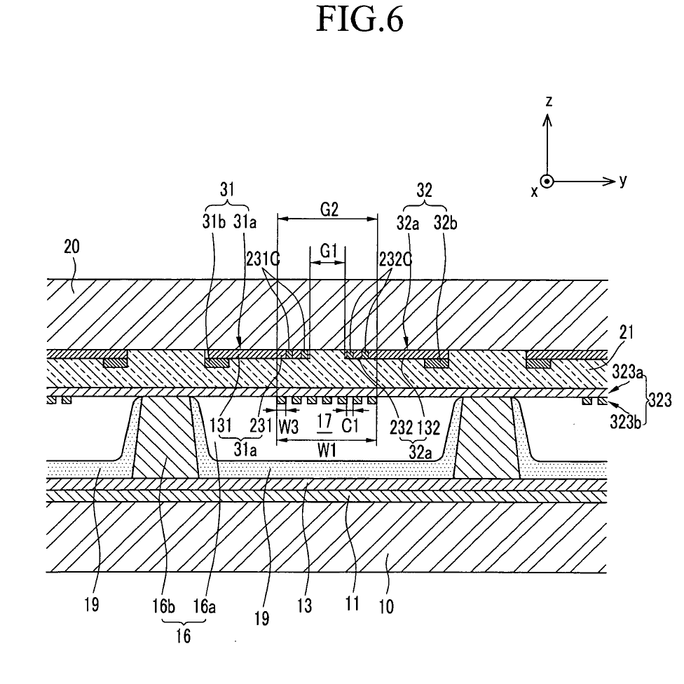

In the second exemplary embodiment shown in FIG. 5 and the third exemplary embodiment shown in FIG. 6, second secondary electron emission portions 223b and 323b are separately formed to correspond to a part of the sustain electrode 31 and a part of the scan electrode 32.

Referring to FIG. 5, the second secondary electron emission portion 223b includes a second secondary electron emission portion 1223b on a sustain electrode side, and a second secondary electron emission portion 2223b on a scan electrode side. The second secondary electron emission portion 1223b on the sustain electrode side is formed to be close to the outer close part 231 on the sustain electrode 31. The second secondary electron emission portion 2223b on the scan electrode side is provided to be apart from the second secondary electron emission portion 1223b on the sustain electrode side while corresponding to the outer close part 232 on the scan electrode 32.

A third gap G3 between the second secondary electron emission portion 1223b on the sustain electrode side and the second secondary electron emission portion 2223b on the scan electrode side is greater than a first discharge gap G1.

The third gap G3 has the same size as a sum of a first gap G13 between a center of the discharge cell 17 and the second secondary electron emission portion 1223b on the sustain electrode side, and a second gap G23 between the center of the discharge cell 17 and the second secondary electron emission portion 2223b on the scan electrode side (G3=G13+G23). The second gap G23 has the same size as the first gap G13.

The second secondary electron emission portion 1223b on the sustain electrode side has a second width W2 and is formed to extend in an x-axis direction, and the second secondary electron emission portion 2223b on the scan electrode side has a second width W2 and is formed to extend in an x-axis direction.

The sustain electrode 31 and the scan electrode 32 form the short-gap discharge portion by the outer close parts 231 and 232 corresponding to the first secondary electron emission portion 223b, and form the long-gap discharge portion by the outer remote parts 131 and 132 corresponding to the first secondary electron emission portion 223a and outside the second secondary electron emission portion 323b.

In further detail, the short-gap discharge portion formed by the outer close parts 231 and 232 is exposed to the second secondary electron emission portion 223b by a part obtained by subtracting the first discharge gap G1 from the third gap G3, and is formed by end parts 231E and 232E corresponding to a covered distance E1 of the first secondary electron emission portion 223a.

Compared to the first exemplary embodiment of the present invention, in the second exemplary embodiment of the present invention, the end parts 231E and 232E of the sustain electrode 31 and the scan electrode 32 allow the short-gap discharge with a lower voltage in the initial discharge, and suppress the short-gap discharge in the full discharge may be reduced.

Referring to FIG. 6, a second secondary electron emission portion 323b includes a plurality of sub-electron emission portions that is arranged with a predetermined interval C1 along a y-axis direction within a range of the first width W1 that is the same as the second discharge gap G2, and are formed as a group while having a third width W3 along an x-axis direction.

The sustain electrode 31 and the scan electrode 32 form the short-gap discharge portion by the outer close parts 231 and 232 corresponding to the second secondary electron emission portion 323b, and form the long-gap discharge portion by the outer remote parts 131 and 132 corresponding to a first secondary electron emission portion 323a.

In further detail, the short-gap discharge portion formed by the outer close parts 231 and 232 is exposed to the second secondary electron emission portion 323b by a part obtained by subtracting the intervals C1 from the outer close parts 231 and 232, and is formed by a portion 231C of the sustain electrode 31 and a portion 232C of the scan electrode 32 corresponding to the interval C1 of the first secondary electron emission portion 323a.

Compared to the first exemplary embodiment, in the third exemplary embodiment the portion 231C of the sustain electrode 31 and the portion 232C of the scan electrode 32 allows the short-gap discharge with a lower voltage in the initial discharge, and suppresses the short-gap discharge in the full discharge may be reduced.

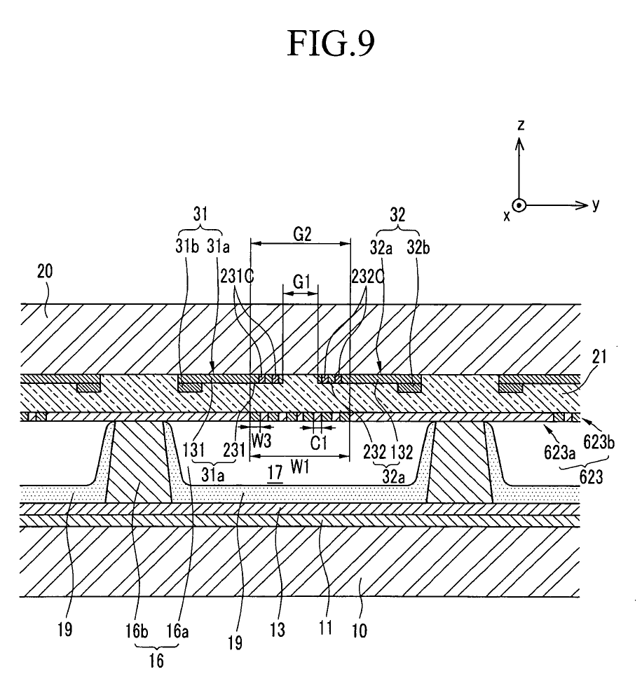

In the fourth exemplary embodiment shown in FIG. 7 to the sixth exemplary embodiment shown in FIG. 9, second secondary electron emission portions 423b, 523b, and 623b are formed on the dielectric layer 21 corresponding to the sustain electrode 31 and the scan electrode 32. The second secondary electron emission portions 423b, 523b, and 623b are formed on the dielectric layer 21 while corresponding to a side of the sustain electrode 31 and a side of the scan electrode 32 between first secondary electron emission portions 423a, 523a, and 623a on a first discharge gap side.

Referring to FIG. 7, the second secondary electron emission portion 423b forms the second discharge gap G2 that is greater than the first discharge gap G1 between the sustain electrode 31 and the scan electrode 32.

The second secondary electron emission portion 423b is integrally formed to correspond to the outer close parts 231 and 232 of the sustain electrode 31 and the scan electrode 32. Accordingly, the sustain electrode 31 and the scan electrode 32 form the second discharge gap G2 in the y-axis direction between both ends of the second secondary electron emission portion 423b.

The sustain electrode 31 and the scan electrode 32 form the short-gap discharge portion by the outer close parts 231 and 232 corresponding to the second secondary electron emission portion 423b, and form the long-gap discharge portion by the outer remote parts 131 and 132 corresponding to the first secondary electron emission portion 423a and outside the second secondary electron emission portion 423b.

The second secondary electron emission portion 423b has the first width W1 that is substantially the same as the second discharge gap G2 and is formed to extend in an x-axis direction. In addition, the second secondary electron emission portions 423b formed through the area of the PDP are formed to be apart from each other by a y-axis direction length of the discharge cell 17 along a y-axis direction. Further, the second secondary electron emission portions 423b and the first secondary electron emission portion 423a are alternately arranged along a y-axis direction.

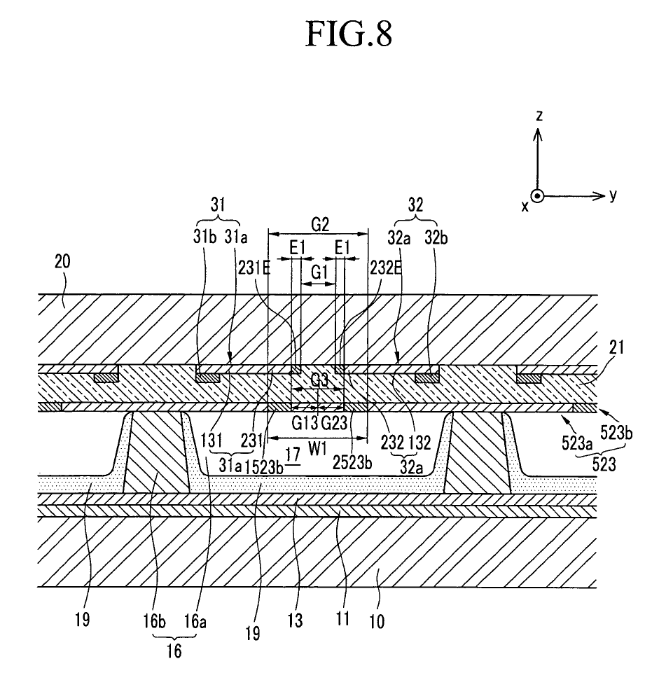

In the fifth exemplary embodiment shown in FIG. 8 and the sixth exemplary embodiment shown in FIG. 9, the second secondary electron emission portions 523b and 623b are formed in plural to correspond to a part of the sustain electrode 31 and a part of the scan electrode 32.

Referring to FIG. 8, the second secondary electron emission portion 523b includes a second secondary electron emission portion 1523b on the sustain electrode side and a second secondary electron emission portion 2523b on the scan electrode side. The second secondary electron emission portion 1523b on the sustain electrode side is formed to correspond to the outer close part 231 of the sustain electrode 31. The second secondary electron emission portion 2523b on the scan electrode side is apart from the second secondary electron emission portion 1523b on the sustain electrode side on the first discharge gap side, and is formed to correspond to the outer close part 232 of the scan electrode 32.

The gap third G3 between the second secondary electron emission portion 1523b on the sustain electrode side and the second secondary electron emission portion 2523b on the scan electrode side is greater than the first discharge gap G1.

The gap third G3 is the same as a sum of a first gap G13 between a center of the discharge cell 17 and the second secondary electron emission portion 1523b on the sustain electrode side, and a second gap G23 between the center of the discharge cell 17 and the second secondary electron emission portion 2523b on the scan electrode side (G3=G13+G23). The second gap G23 is the same as the first gap G13.

The second secondary electron emission portion 1523b on the sustain electrode side has a second width W2 and is formed to extend in an x-axis direction, and the second secondary electron emission portion 2523b on the scan electrode side has a second width W2 and is formed to extend in an x-axis direction.

The sustain electrode 31 and the scan electrode 32 form the short-gap discharge portion by the outer close parts 231 and 232 corresponding to the first secondary electron emission portion 523a and inside the second secondary electron emission portions 523b, and form the long-gap discharge portion by the outer remote parts 131 and 132 corresponding to the first secondary electron emission portion 523a and outside the second secondary electron emission portion 523b.

In further detail, the short-gap discharge portion formed by the outer close parts 231 and 232 is exposed to the second secondary electron emission portion 523b by a part obtained by subtracting the first discharge gap G1 from the gap G3, and is formed by end parts 231E and 232E corresponding to a covered distance E1 of the first secondary electron emission portion 523a.

Referring to FIG. 9, the second secondary electron emission portion 632b includes a plurality of sub-electron emission portions that is arranged with the predetermined interval C1 along a y-axis direction within a range of the first width W1 that is the same as the second discharge gap G2, and are formed as a group while having the third width W3 along an x-axis direction.

The sustain electrode 31 and the scan electrode 32 form the short-gap discharge portion by the outer close parts 231 and 232 corresponding to the second secondary electron emission portion 623b, and form the long-gap discharge portion by the outer remote parts 131 and 132 corresponding to a first secondary electron emission portion 623a and outside the second secondary electron emission portion 623b.

In further detail, the short-gap discharge portion formed by the outer close parts 231 and 232 is exposed to the second secondary electron emission portion 623b by a part obtained by subtracting the intervals C1 from the outer close parts 231 and 232, and is formed by parts 231C and 232C corresponding to the interval C1 of the first secondary electron emission portion 623a.

As described, in the PDP according to the exemplary embodiments of the present invention, the protective layer on the dielectric layer covering the first and second electrodes is formed by the first and second secondary electron emission portions having different secondary electron emission coefficients.

The first secondary electron emission portion has a higher secondary electron emission coefficient, and the second secondary electron emission portion has a lower secondary electron emission coefficient.

The first secondary electron emission portion is formed on a part corresponding to the first and second electrodes, and the second secondary electron emission portion is formed on a part corresponding to parts of the first and second electrodes of the first discharge gap outer close part on one side of the first discharge gap between the first and second electrodes.

Accordingly, the initial discharge is induced as the short-gap discharge to prevent the increase of the discharge firing voltage, and induces the full discharge as the long-gap discharge after the initial discharge. Therefore, in the full discharge, since the short-gap discharge is suppressed and the long-gap discharge is induced, the luminous efficiency may be improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display panel (PDP) comprising:
a first substrate;
a second substrate facing the first substrate;
a barrier rib provided between the first and second substrates and defiring a discharge cell;
a phosphor layer formed in the discharge cell;
an address electrode formed on an inner surface of the first substrate and extending in a first direction;
a first electrode formed on an inner surface of the second substrate and extending in a second direction, the second direction being substantially perpendicular to the first direction;
a second electrode formed on the inner surface of the second substrate and extending in the second direction, a first discharge gap being formed between the first electrode and the second electrode;
a dielectric layer formed on the second substrate and covering the first and second electrodes; and
a protective layer covering the dielectric layer, the protective layer comprising:
a first secondary electron emission portion that is formed to correspond to outer remote parts of the first and second electrodes and has a first secondary electron emission coefficient; and
a second secondary electron emission portion that is formed to correspond to an outer close part of one of the first and second electrodes and has a second secondary electron emission coefficient that is smaller than the first secondary electron emission coefficient.

2. The PDP of claim 1, wherein the second secondary electron emission portion is formed to correspond to outer close parts of both of the first electrode and the second electrode.

3. The PDP of claim 1, wherein the first secondary electron emission portion is formed on the dielectric layer, and the second secondary electron emission portion is formed on the first secondary electron emission portion.

4. The PDP of claim 3, wherein the first secondary electron emission portion includes a MgO protective layer, and the second secondary electron emission portion includes a discharge deactivation film (DDF).

5. The PDP of claim 3, wherein the DDF includes Al₂O₃ or TiO₂.

6. The PDP of claim 3, wherein the second secondary electron emission portion forms a second discharge gap that is greater than the first discharge gap.

7. The PDP of claim 3, wherein the second secondary electron emission portion covers the first discharge gap.

8. The PDP of claim 7, wherein the second secondary electron emission portion forms a second discharge gap that is greater than the first discharge gap, the second secondary electron emission portion having a first width that is substantially the same as the second discharge gap and extending in the second direction.

9. The PDP of claim 7, wherein the first and second electrodes form a short-gap discharge portion by the outer close parts corresponding to the second secondary electron emission portion, and form a long-gap discharge portion by the outer remote parts corresponding to the first secondary electron emission portion and outside of the second secondary electron emission portion.

10. The PDP of claim 3, wherein the second secondary electron emission portion includes a plurality of sub-electron emission portions corresponding to a part of the first electrode and a part of the second electrode.

11. The PDP of claim 10, wherein the sub-electron emission portions have a predetermined interval therebetween along the first direction, and each of the sub-electron emission portions has a third width measured along the first direction within a range of the first width.

12. The PDP of claim 11, wherein the first electrode and the second electrode form a short-gap discharge portion by the close part corresponding to the second secondary electron emission portion and a long-gap discharge portion by remote parts corresponding to the first secondary electron emission portion and outside the second secondary electron emission portion.

13. The PDP of claim 3, wherein the second secondary electron emission portion comprises:
a first electrode side second secondary electron emission portion corresponding to a close part of the first electrode; and
a second electrode side second secondary electron emission portion that is apart from the first electrode side second secondary electron emission portion on a first discharge gap side, and corresponds to a close part of the second electrode.

14. The PDP of claim 13, wherein a gap between the first electrode side second secondary electron emission portion and the second electrode side second secondary electron emission portion is greater than the first discharge gap.

15. The PDP of claim 14, wherein the gap is the same as a sum of a first distance from a center of the discharge cell to the first electrode side second secondary electron emission portion and a second distance from the center of the discharge cell to the second electrode side second secondary electron emission portion, the second distance being the same as the first distance.

16. The PDP of claim 15, wherein the first electrode side second secondary electron emission portion has a second width extending in the second direction, and the second electrode side second secondary electron emission portion has the second width extending in the second direction.

17. The PDP of claim 14, wherein the first and second electrodes form a short-gap discharge portion by the close parts corresponding to the first secondary electron emission portion and inside the second secondary electron emission portions, and form a long-gap discharge portion by the remote parts of the first electrode and the second electrode corresponding to the first secondary electron emission portion and outside the second secondary electron emission portion.

18. The PDP of claim 1, wherein the first secondary electron emission portion is formed on the dielectric layer corresponding to the first electrode and the second electrode, and the second secondary electron emission portion is formed on the dielectric layer to correspond to a part of the first electrode and a part of the second electrode, the second secondary electron emission portion being formed on a portion of the dielectric layer on which the first secondary electron emission portion is not formed.

19. The PDP of claim 18, wherein the second secondary electron emission portion forms a second discharge gap that is greater than the first discharge gap.

20. The PDP of claim 18, wherein the second secondary electron emission portion covers the first discharge gap.

21. The PDP of claim 20, wherein the second secondary electron emission portion forms a second discharge gap that is greater than the first discharge gap, the second secondary electron emission portion having a first width that is substantially the same as the second discharge gap and extending in the second direction.

22. The PDP of claim 20, wherein the first and second electrodes form a short-gap discharge portion by the close parts corresponding to the second secondary electron emission portion, and form a long-gap discharge portion by the remote parts corresponding to the first secondary electron emission portion and outside the second secondary electron emission portion.

23. The PDP of claim 18, wherein the second secondary electron emission portion includes a plurality of sub-electron emission portions corresponding to the close part of the first electrode and the close part of the second electrode.

24. The PDP of claim 23, wherein the sub-electron emission portions have a predetermined interval therebetween along the first direction, and each of the sub-electron emission portions has a third width measured along the first direction within a range of the first width.

25. The PDP of claim 24, wherein the first and second electrodes form a short-gap discharge portion by the close parts corresponding to the second secondary electron emission portion, and form a long-gap discharge portion by the remote parts corresponding to the first secondary electron emission portion and outside the second secondary electron emission portion.

26. The PDP of claim 18, wherein the second secondary electron emission portion comprises:
a first electrode side second secondary electron emission portion corresponding to the close part of the first electrode; and
a second electrode side second secondary electron emission portion that is apart from the first electrode side second secondary electron emission portion on the first discharge gap side and corresponds to the close part of the second electrode.

27. The PDP of claim 26, wherein a gap between the first electrode side second secondary electron emission portion and the second electrode side second secondary electron emission portion is greater than the first discharge gap.

28. The PDP of claim 27, wherein the gap is the same as a sum of a first distance from a center of the discharge cell to the first electrode side second secondary electron emission portion and a second distance from the center of the discharge cell to the second electrode side second secondary electron emission portion, the second distance being the same as the first distance.

29. The PDP of claim 28, wherein the first electrode side second secondary electron emission portion has a second width and extends in the second direction, and the second electrode side second secondary electron emission portion has the second width and extends in the second direction.

30. The PDP of claim 27, wherein the first electrode and the second electrode form a short-gap discharge portion by the close parts corresponding to the first secondary electron emission portion and inside the second secondary electron emission portions, and form a long-gap discharge portion by remote parts of the first and second electrodes corresponding to the first secondary electron emission portion and outside the second secondary electron emission portion.
